(19) United States
(12) Patent Application Publication
(10) Pub. No.: US 2007/0146973 A1
(43) Pub. Date: Jun. 28, 2007

(54) On-board power system of a motor vehicle

(76) Inventor: Heinz Leiber, Oberriexingen (DE)

Correspondence Address: REED SMITH LLP, 3110 FAIRVIEW PARK DRIVE, SUITE 1400, FALLS CHURCH, VA, 22042, US

(21) Appl. No.: 10/541,351

(22) PCT Filed: Jan. 5, 2004
(86) PCT No.: PCT/DE04/00005

§ 371 Date: Feb. 22, 2006

(30) Foreign Application Priority Data
Jan. 7, 2003 (DE) 103-00-464.5

(51) Int. Cl. H02B 1/26

(52) U.S. Cl. 361/641

(57) ABSTRACT

The invention relates to an on-board power system for a motor vehicle. A central electronic system housed in a box is accommodated close to the engine compartment bulkhead and connecting cables from the engine compartment to the electrical connectors on this box do not pass through the bulkhead.

The invention relates to an on-board power system for a motor vehicle with the features described in the preamble of claim 1.

An on-board power system of such kind is known for example from the VDI reports from 2001 on page 1109. Several central electronic systems or signal processing modules that are connected via buses to various consumer groups are provided there. These electronic systems also include fuse boxes for fuse protection and power distribution that are arranged separately and mounted on the electronic system boxes.

In these cases, with many current circuits in the fuse box the fused path is looped through the central electronic system, because the current is distributed in the central electronic system connected thereafter. This requires additional plugged contacts, and the two devices mean that a large installation space is required. The wires often pass through separating walls from the fuse box to the central electronic system via bushings, which is complicated and also allows noise to pass through, e.g. from the engine compartment, because the fuse box is usually accommodated in the engine compartment. From the fuse box and the central electronic systems—two of these are usually used in motor vehicles—the wiring bundle is routed chaotically to the individual consumers.

The object of the invention is to do away with these drawbacks.

This object is attained with the features of claim 1. Further configurations of the invention are listed in the subordinate claims.

Exemplary embodiments of the invention will be described with reference to the drawing.

In the drawing:

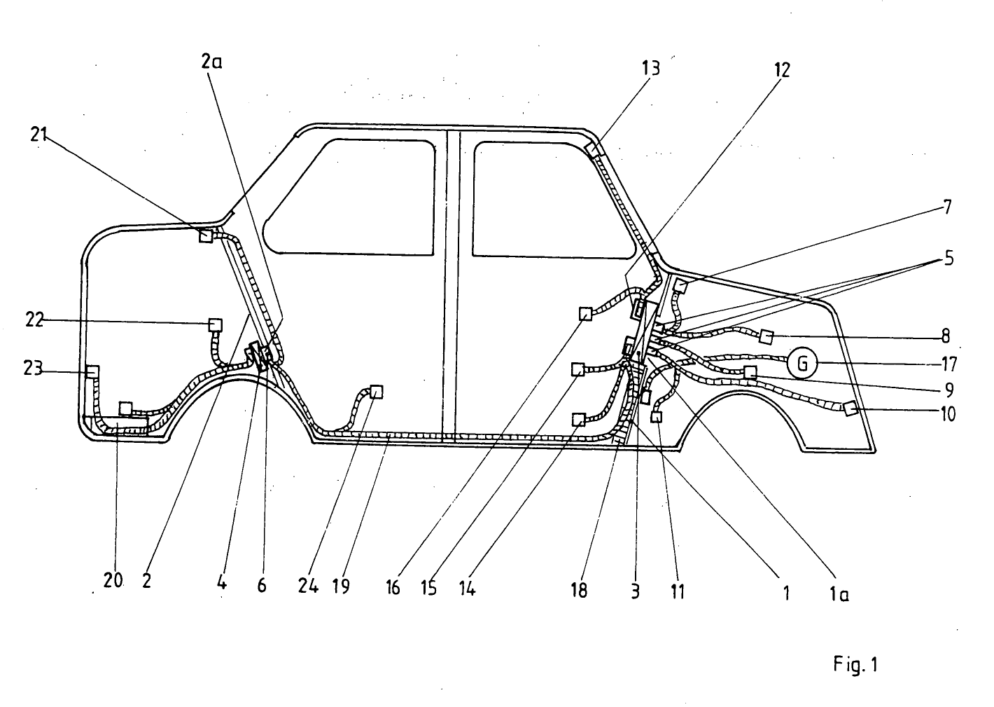

FIG. 1 shows a simplified body of a standard motor car;

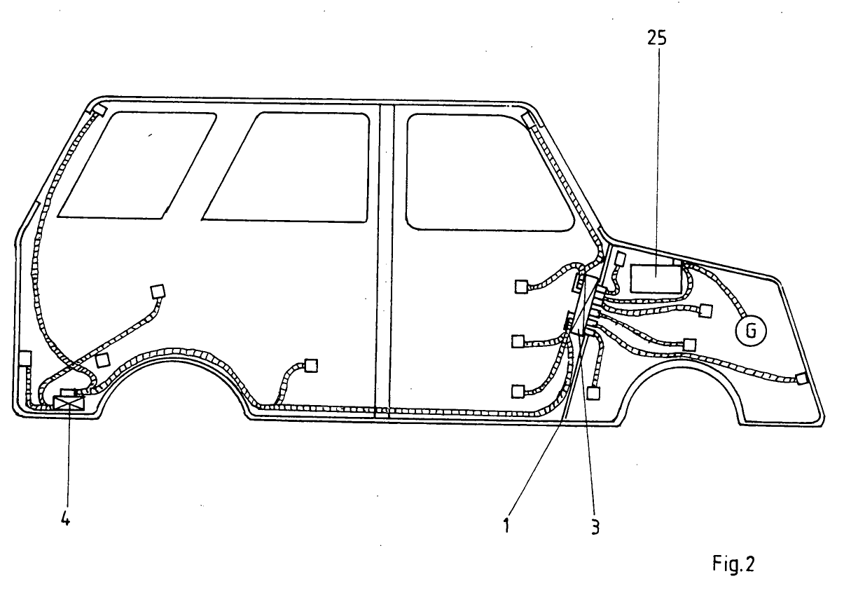

FIG. 2 shows the body of a station wagon;

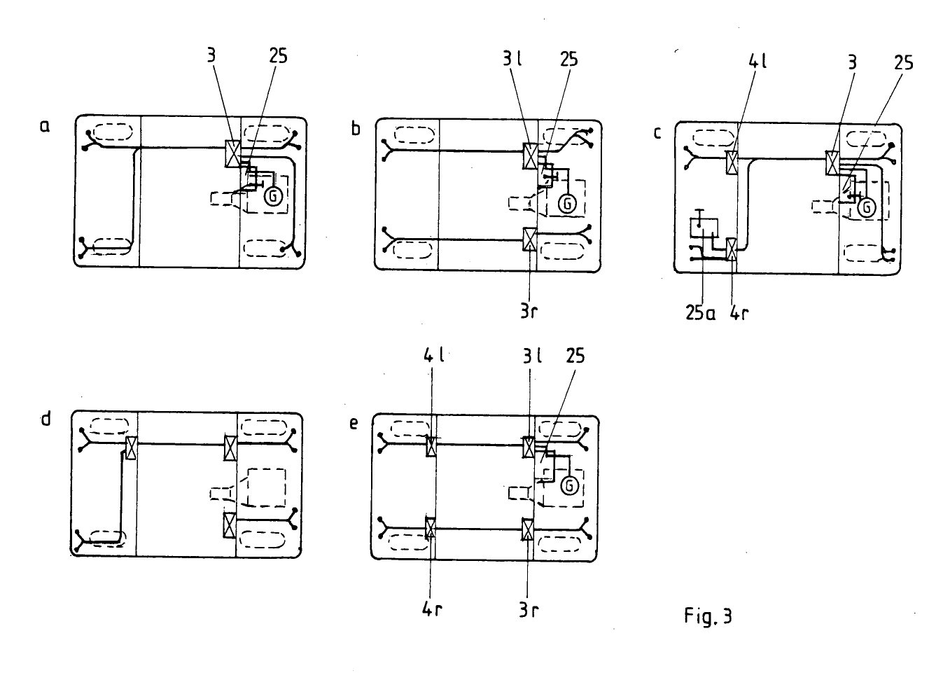

FIGS. 3a to 3e show the systematics of possible arrangements of central electronic systems;

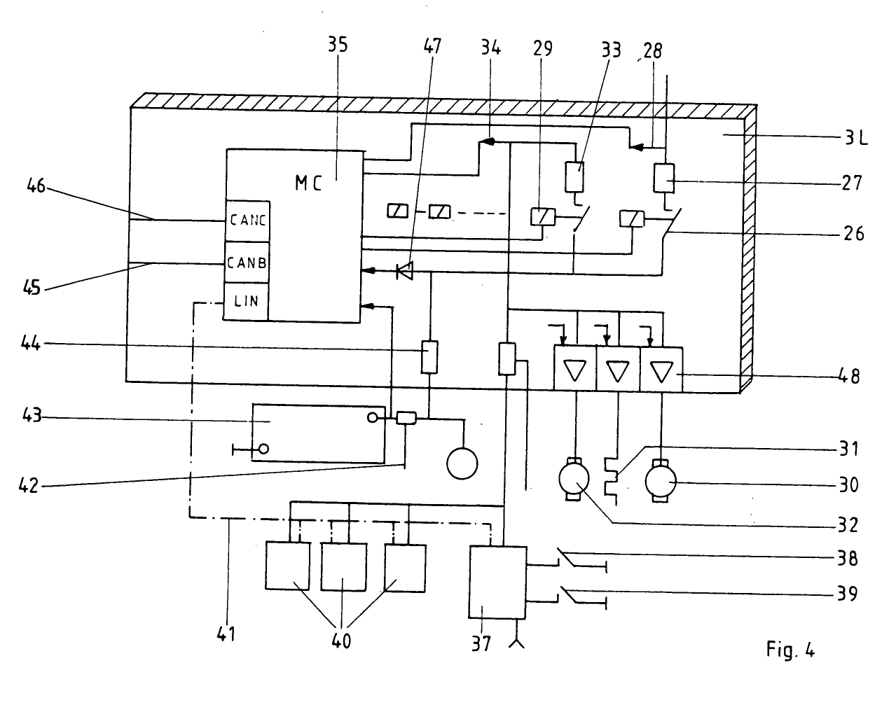

FIG. 4 shows the possible schematic of a central electronic system;

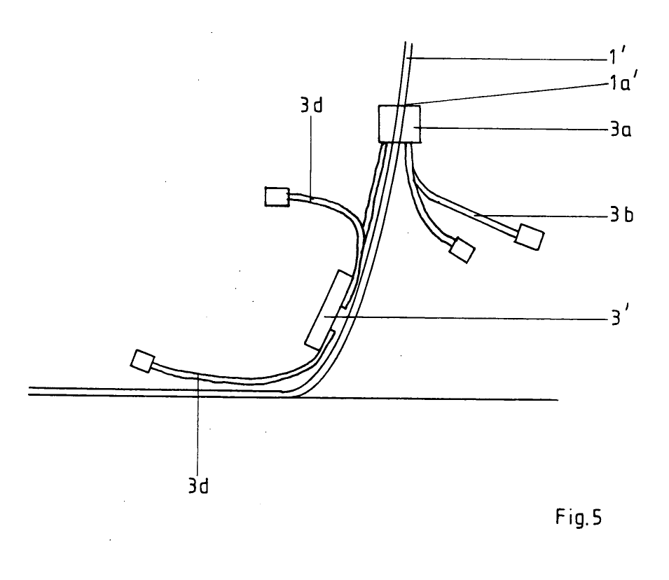

FIG. 5 shows a different accommodation solution than the one in FIGS. 1 to 3.

FIG. 1 shows a standard motor car with a bulkhead 1 at the front and a bulkhead 2 at the rear. Two central electronic systems with integral fuse box accommodated in boxes 3, 4, and which will be referred to in the following as SP boxes, are attached to bulkheads 1 or 2 with passthroughs 1a and 2a. It is advantageous if power and signal distribution is combined in the SP box without the aforementioned splitting. Power distribution is understood to mean for example actuating a motor, signal distribution is reading in switches and sensor and bus signals. More generally in this context, the power circuits are not protected by conventional fuses, but instead by switches (MOSFETS or relays) together with a current measuring component, e.g. a shunt. In this way, the current may be monitored and switched off in the event of a short circuit. For smaller currents, a reversible fuse, e.g. a so-called polyswitch may be used. The box for such a central electronic system with integrated signal and power processing including all its fuses will be designated in the following as an SP (signal and power) box. Here for example it has electrical connections on both sides. Plugs 5 and 6 are provided on the front in FIG. 1.

In the front bulkhead 1 for the engine compartment, the passthroughs are constructed so that they are insulated by one wall of box 3 on the passenger cabin side being placed tightly against bulkhead 1. Bulkhead 1 is furnished with an opening la that faces this wall so that connecting wires may pass through to the consumers in the engine compartment. As was stated previously, the connections between these wires and the connections in box 3 are in the form of plug connectors. These plugs 5 are connected to individual, relatively short wiring harnesses, the other ends of which are themselves connected to plugs. For example, a plug 7 is connected to the electric windscreen wipers and the windscreen heater; plug 8 is connected to the ABS controller and switches in the middle area of the engine compartment, plug 9 is connected to the engine and transmission controller, plug 10 to the front headlights, beam range regulator and headlight wipers, plug 11 to consumers in the lower area of the engine compartment, such as the fresh air fan and the heater valves. For reasons of cost and also because of the limited installation space, the wiring harnesses in the passenger cabin are preferably connected directly with connectors on the central electronic system box, e.g. via clamping connectors 12. The mating halves e.g. 13 are connected to the roof module, 14 to the door consumers, 15 to the central console, and 16 to the cockpit consumers such as the instrument cluster, heating/air conditioning control etc. One wire connects the generator 17 with an electrical energy storage device, preferably an ultra cap 18. This is known to have considerable advantages during starting and energy regeneration. Due to temperature limitations and the short wire to the generator, the ultra cap is therefore preferably housed in the footwell. Generator 17 is preferably an integral starter generator. The consumers in the rear and the rear central electronic system are supplied with power via a wiring harness 19. This circuit may be extended to a backup battery 20 in the trunk. As with the SP box 3 in the front, wires are attached to rear box 4, or connected via plugs, and the other ends 21 of these wires are connected to the trunk, 22 to devices such as navigation, telephone, sound system, for example, and 23 to lights and 24 to the rear doors. The outstanding features in this context are the relatively short wiring harnesses. The arrangement of SP boxes 3 and 4 on bulkheads 1 and 2 means that bushings are not required and wires do not have to be threaded through. The short, simply organized wiring harnesses may be manufactured largely automatically.

FIG. 2 shows the structure of a station wagon, in which there is no rear bulkhead. In this case, SP box 4 is installed in the very rear of the vehicle and has the same wiring harness structure to the consumers as the box in the front.

FIG. 3 shows systematics of possible arrangements of the SP boxes:

FIG. 3a shows an arrangement with just one box 3 in the front;

FIG. 3b shows an arrangement with two SP boxes 31, 3r in the front left and right; in both cases the SP box is connected to battery 25 and generator G;

FIG. 3c shows an arrangement with one SP box 3 in the front and two SP boxes 4r and 4l in the rear; in this case, two energy storage devices, a starter battery 25 and a supply battery 25a are provided, and have electrical connections to the SP boxes assigned to them. An ultra cap may also be used instead of battery 25. Generator G is usually connected to front energy storage device 25.

FIG. 3d shows two SP boxes in the front and one SP box in the rear;

FIG. 3e shows two SP boxes in the front and two SP boxes in the rear.

This last configuration is the most favorable with respect to the symmetry of the wiring harnesses and the length of the wires. As with 3c, in this case, too, a second energy storage device may be connected to one of the SP boxes (advantageously in the rear section). It is expedient to house the essential basic functions of the on-board power supply in these boxes. These would include
lighting control (beam range and cornering adjustment if present)
windscreen washer controller
gateway
battery/power management
roof controller
evaluation of attached sensors, such as tire pressure monitoring or parking assistance, master functions for bus systems, e.g. LIN bus. Evaluation of signals of tire pressure monitoring sensors transmitted wirelessly (HF) is particularly convenient since the front and rear SP boxes simply need to be provided with an internal or external aerial at the rear. The signal is evaluated by an MC. Communication with the other SP boxes takes place via a bus connection.

The assignment of the functions to the individual boxes is determined principally by the proximity of the consumers and the loading on the plugs, the interface, and the microcontroller(s) provided in the box.

FIG. 4 shows the block diagram of a box, e.g. front left 31, in the basic configuration. Rear left SP box 41, the front left door and the seat are powered via a relay 26 and a shunt 27. The current-proportional voltage signal is sent to MC 35 via circuit 28. Relay 29 with a shunt 33 supplies some power amplifiers e.g. for windscreen wiper controller 30, windscreen washer fluid heater 31 and washer fluid pump 32. The current is measured across shunt 33 and a measurement circuit 34 and is checked in microcomputer (MC) 35 for plausibility against the load switched via the power amplifiers. If it fails the plausibility check, the error is signaled to a diagnostics system or appears on a display. The actuator circuit from MC 35 is not fully shown at power amplifiers 48. A polyswitch 36 for supplying power upstream of the small bus node, e.g. based on LIN 41, is also integrated via the power circuit to the power amplifiers. In a variant of the configuration described above, this bus node may contain for example tire pressure monitoring receiver 37. Since this receiver is located close to the suspension strut, switch signals such as brake lining wear 38 and windscreen washer fluid level 39 are read in to relieve the load on the cable loom. Other LIN nodes are the sensors for the parking aid 40, which are connected to bus circuit 41. If a short circuit occurs, polyswitch 36 is locked and this is reported to MC 35 via shunt 33. Even the failure of a power amplifier, for example, may be detected, again by the plausibility check. Such an occurrence is unlikely, but if it does happen with a high short circuit current, the entire branch is shut down. Even partial short circuits are detectable.

When the vehicle has been switched off, relay 29 opens and the quiescent current is 0 to relieve the battery, so that faulty leakage currents do not completely drain the battery 43. For battery management, the current from and to battery 43 may be measured with current measurement element 42 and the current from the generator to MC 35 may be measured with an element 44. MC 35 is also connected to CAN B 45 and CAN C 46; this is essential for the gateway function. Depending on the consumers connected, relays, power amplifiers and/or polyswitches are provided in SP box 3. MOSFETs may also be used instead of relays. The advantages of relays are:
inverse polarity protection
no leakage currents and
low thermal power loss due to low contact resistance.

The box described is protected against polarity inversion, the MC is protected by a diode 47.

The design according to the invention may also be implemented in a multi-voltage on-board power supply in which the consumers are powered by a generator and theoretically by one or two batteries in parallel.

The central electronic system in the SP boxes may be designed such that one SP box functions as master in the software structure and the other SP boxes function as slaves, i.e. they only receive signals and actuate consumers. Processing is thus performed by one slave box in each case. In this case, the slave boxes may also be configured such that if the master SP box fails they start an emergency program to ensure minimum functioning.

FIG. 5 shows front bulkhead 1′. SP box 3′ is located in the footwell of the front passenger area, but as close as possible to bulkhead 1′, so that the connections are kept as short as possible. Bulkhead 1′ is furnished with a passthrough 1′, into which a splitter 3a is placed not only for connector cables 3b to the engine consumers, but also for cables 3c to SP box 3′. Connector cables 3b and/or 3c may be connected to splitter 3a via plugs.

Cables 3d also run from box 3′ to the consumers and/or switches in the passenger cabin. In this case, all connectors to box 3′ are provided on one side in box 3′.

1. An on-board power system for a motor vehicle with a large number of consumers and at least one central electronic system housed in a box, wherein the consumers are connected with this at least one central electronic system, and with a body bulkhead between the engine compartment and the passenger cabin, characterized in that
the at least one central electronic system housed in the box is located at least close to the body bulkhead on the passenger cabin side, and that at least one sealed splitter (passthrough) is provided for the connecting cables running from the connectors on the box for the central electronic system to the consumers in the engine compartment.

2. The on-board power system according to claim 1, characterized in that
the at least one box is mounted flush and directly on the body bulkhead , and that the at least one splitter (passthrough) faces a side of the box that is furnished with connectors, and that the connecting cables for the engine compartment are connected to these connectors.

3. The on-board power system according to claim 1, characterized in that
at least one sealed splitter (passthrough) that is furnished with connectors on both sides is located in the body bulkhead, the connectors on the one side of the splitter connecting the cables to the consumers, and on the other side connecting short connecting cables to the connectors on box.

4. The on-board power system according to claim 1, characterized in that
two boxes for the two sides of the vehicle are arranged on the bulkhead.

5. The on-board power system according to claim 1, characterized in that
at least one further box, preferably two boxes for the two sides of the vehicle, are arranged in the rear space, particularly on the rear bulkhead.

6. The on-board power system according to claim 1, characterized in that
as well as the central electronic system, switching means for the fuse and distribution function (SP boxes) are also integrated in the box/boxes, and preferably protect all low and high current circuits to the adjacent consumers in the SP box.

7. The on-board power system according to claim 6, characterized in that
the signal and power circuits originate from the SP box/SP boxes.

8. The on-board power system according to claim 5, characterized in that
the outputs from the connecting cables are protected by switches (Mosfets and/or relays) and/or reversible fuses (polyswitches).

9. The on-board power system according to claim 6, characterized in that
the individual SP boxes serve all the functions of the neighboring space.

10. The on-board power system according to claim 1, characterized in that
the connectors on box/boxes are constructed as plugs and/or as direct contacts.

11. The on-board power system according to claim 10, characterized in that
one side of each of the boxes is furnished with plugs, and the other side is furnished with direct contacts.

12. The on-board power system according to claim 1, characterized in that
each of the boxes is connected to the respectively adjacent consumers and sensors.

13. The on-board power system according to claim 6, characterized in that
an energy storage device is connected to at least one of the SP boxes.

14. The on-board power system according to claim 13, characterized in that
the energy storage device and the associated SP box that are used to start the engine are situated close to the engine, and that the generator is connected to this energy storage device.

15. The on-board power system according to claim 13, characterized in that
this SP box assigned to the energy storage device supplies current to the other SP boxes.

16. The on-board power system according to claim 5, characterized in that
the front SP box(es) distribute the current for the rear space (inside and trunk) and provide electrical protection therefor.

17. The on-board power system according to claim 6, characterized in that
a second battery (backup battery) is housed in the rear section of the vehicle and is connected to the SP box that is located there.

18. The on-board power system according to claim 6, characterized in that
one SP box assumes the master function in the software structure and the other SP boxes assume slave functions (i.e. they only receive signals and actuate consumers).

19. The on-board power system according to claim 18, characterized in that the slave boxes include an emergency program for minimum processing in the event that the master SP box fails.
